(19) United States
(12) Patent Application Publication
(10) Pub. No.: US 2010/0196611 A1
(43) Pub. Date: Aug. 5, 2010

(54) NANOCOMPOSITES AND PROCESS FOR THEIR PRODUCTION

(76) Inventors: Nopphawan Phonthammachai, Singapore (SG); Chaobin He, Singapore (SG); Xu Li, Singapore (SG)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/722,665

(22) Filed: Mar. 12, 2010

Related U.S. Application Data
(63) Continuation-in-part of application No. 11/632,004, filed on Sep. 26, 2007.

(51) Int. Cl. B05D 3/02; C08K 5/54

(52) U.S. Cl. 427/386; 524/174

(57) ABSTRACT

A process of forming a composite material comprising treating pristine clay with water to form a swollen clay, intercalating the swollen clay with an organic solvent to form an organic solvent intercalated swollen clay by exchanging the water with the organic solvent while maintaining the swollen clay in a swollen state with the solvent. The organic solvent intercalated swollen clay is then treated with a silane coupling agent and the organic solvent intercalated swollen clay so modified is mixed with an epoxy matrix material to form a nanocomposite. The nanocomposite is then applied to a reinforcing material to thereby form a composite material.

### CROSS-REFERENCE TO RELATED APPLICATION

This application is a continuation-in-part of U.S. patent application Ser. No. 11/632,004 filed on Jan. 9, 2007, which is a national phase application of PCT/SG04/00212, filed Jul. 14, 2004, the contents of which documents are herein incorporated by reference in their entirety.

### FIELD OF THE INVENTION

This invention relates to nanocomposites, a process for their production and their use in forming composite materials.

### BACKGROUND OF THE INVENTION AND PRIOR ART

One of the major problems preventing polymer/clay nanocomposite manufacturing on a large scale is the difficultly in achieving a high degree of clay exfoliation and uniform dispersion in polymer/clay systems to form a true nanostructure. The anticipated high performance of polymer/clay nanocomposites, such as high strength and modulus, good barrier properties, improved fire retardant and scratch resistance are believed to be the direct result of the ultra-high aspect ratio as well as the extremely large surface area of the exfoliated nanoclay. Without the required degree of clay exfoliation, it has been shown that the improvement in desirable properties sought by the addition of nanoclay to a rigid polymer matrix is very limited and, in some cases, a negative impact has even been reported.

Pristine clay is a preferred starting material for the production of such nanocomposites. However, the surface of pristine clay is hydrophilic and therefore not compatible with most polymers. To overcome this problem, organic modifiers are widely used to modify the clay surface and improve the extent of exfoliation. The modified clay, which is commonly known as “organoclay”, often needs to contain a considerable amount of an organic modifier. Consequently, the price of organoclay is high and, furthermore, residual low molecular weight modifiers remain in the nanocomposite, which can cause deterioration of the thermal and mechanical performances of the product.

Clay-containing nanocomposites are widely used in the preparation of composite materials, such as carbon fibre-reinforced polymers (CFRPs), as they have been shown to enhance the thermal and mechanical properties of the composite material. However, the improvements in mechanical strength which can be gained by the use of clay-containing nanocomposites is limited by the degree of exfoliation of the clay nanoparticles which can be achieved as well as the extent of the interfacial interactions formed between the clay and resin matrix.

Composite materials have already demonstrated excellent properties in terms of corrosion and fatigue-damage resistance, as well reducing the weight of structures of which they are a part. However, the limitations described above have generally prevented the use of composite materials, for example clay in epoxy resin CFRPs, from being used in structural or otherwise heavy load bearing applications.

This invention provides a novel approach to preparation of nanocomposites and nanocomposites so obtained and their use in the preparation of composite materials and the composite materials thereby obtained.

### SUMMARY OF THE INVENTION

In accordance with the invention there is provided a process of forming a composite material comprising:
(a) treating pristine clay with water to form a swollen clay;
(b) intercalating the swollen clay with an organic solvent to form an organic solvent intercalated swollen clay by exchanging the water with the organic solvent while maintaining the swollen clay in a swollen state with the solvent;
(c) modifying the organic solvent intercalated swollen clay with a silane coupling agent;
(d) mixing the organic solvent intercalated swollen clay so modified with an epoxy matrix material to form a nanocomposite; and
(e) applying the nanocomposite to a reinforcing material; to thereby form a composite material.

Preferably, the treatment of the pristine clay with water results in substantially complete exfoliation of the pristine clay.

Suitably, intercalating the substantially completely exfoliated clay with the organic solvent results in the exfoliated state of the clay being substantially maintained.

### BRIEF DESCRIPTION OF THE DRAWINGS

FIG. 1 shows an optical micrograph of polished surface epoxy DER332/organoclay (epoxy/Cloisite 93A) nanocomposites (clay content 2.5 wt %) of the prior art. (Scale bar: right 50 μm);

FIG. 2 shows an optical micrograph of polished surface epoxy DER332/pristine clay nanocomposites (clay content of 2.5 wt %), according to the present invention. (Scale bar: right 50 μm);

FIG. 3 shows a TEM micrograph of the epoxy DER332/organoclay (epoxy/Cloisite 93A) nanocomposites (clay content of 2.5 wt %) of the same prior art shown in FIG. 1;

FIG. 4 shows a TEM micrograph of epoxy DER332/clay nanocomposites (clay content of 2.5 wt %) prepared according to the technique of the present invention;

FIG. 5 shows the mechanical properties of epoxy DER332/clay nanocomposites of the invention using Young's modulus;

FIG. 6 shows the mechanical properties of epoxy DER332/clay nanocomposites of the invention using fracture toughness;

FIG. 7 shows the comparison of the Young's Modulus of the nanocomposites of the invention prepared using different methods. (Ref: Becker, Cheng, Varley, Simon, Macromolecules, 2003, 36, 1616-1625). Ref A was cured at 100° C. 2 h, 130° C. 1 h, 160° C. 12 h, 200° C. 2 h. Ref B was cured at 160° C. 12 h, 200° C. 2 h;

FIG. 8 shows the comparison of the fracture toughness of the nanocomposites of the invention prepared using different methods. (Ref: Becker, Cheng, Varley, Simon, Macromolecules, 2003, 36, 1616-1625). Ref A was cured at 100° C. 2 h, 130° C. 1 h, 160° C. 12 h, 200° C. 2 h. Ref B was cured at 160° C. 12 h, 200° C. 2 h;

FIG. 9 shows the storage modulus, E′ versus temperature for neat epoxy, epoxy DER332/clay nanocomposites of the invention and that of an epoxy DER332/organoclay nanocomposite (epoxy/Cloisite 93A) of the prior art;

FIG. 10 shows the tan δ versus temperature for epoxy DER332/clay nanocomposites of the invention and that of an epoxy DER332/organoclay nanocomposite (epoxy/Cloisite 93A). In FIGS. 9 and 10, curve a is neat epoxy, curves b, c, d and e are 1.0, 2.5, 3.5 and 5.0 wt % clay respectively. Curve f contains 5.0 wt % Cloisite 93A;

FIG. 11 shows light transmittance of nanocomposites according to the invention at various clay concentrations. Curves a, b, c and d are at 1.0, 2.5, 3.5 and 5.0 wt % clay respectively;

FIG. 12 shows a comparison of light transmittance of a nanocomposite according to a prior art approach (Ref: Deng, et al., Polymer International, 2004, 53, 85-91);

FIG. 13 shows a TEM micrograph of epoxy LY5210/clay nanocomposites (clay content 2.5 wt %) prepared by the technique of the present invention;

FIG. 14 shows the storage modulus, E′ versus temperature for epoxy LY5210/clay nanocomposites of the invention;

FIG. 15 shows the tan δ versus temperature for epoxy LY5210/clay nanocomposites of the invention. In FIGS. 14 and 15, curve a is neat epoxy, curves b and c are 2.5 and 5.0 wt % clay respectively;

FIG. 16 shows the mechanical properties of an epoxy LY5210/clay nanocomposite of the invention using fracture toughness;

FIG. 17 shows a TEM micrograph of an epoxy DER332/clay nanocomposite (clay content of 2.5 wt %) prepared according to the technique of the present invention;

FIG. 18 shows a TEM micrograph of an epoxy DER332/clay nanocomposite (clay content of 2.5 wt %) prepared according to the technique of the present invention;

FIG. 19 shows a TEM micrograph of an epoxy DER332/clay nanocomposite (clay content of 1.0 wt %) prepared according to the technique of the present invention;

FIG. 20 is a representation of one form of equipment useful in laminating a composite material formed by the process of the present invention;

FIG. 21 is a graphical representation of the curing profile of a composite material formed by the process of the present invention; and

FIG. 22 is a series of scanning electron micrograph (SEM) images showing the fracture surfaces of composite materials comprising (a) neat epoxy, no clay; (b) 1 wt % clay in epoxy, no coupling agent; and (c) 1 wt % clay in epoxy and silane coupling agent.

### DETAILED DESCRIPTION OF THE INVENTION

By the invention, pristine clay is first dispersed in water to form a dispersion. This causes swelling of the individual clay particles by penetration of the water into the clay gallery spaces. The water is then exchanged with an organic solvent, while in the presence of the water. The choice of solvent and the conditions of exchange are such that the swollen state of the clay is maintained. By using an organic solvent, the amount of organic modifiers can be reduced while exfoliation of the clay particles is improved. Substantially complete exfoliation can be achieved in at least the preferred forms of the invention.

The organic solvent used in this invention facilitates the reaction between the modifier and the clay and also facilitates the uniform dispersion of the clay layers in the monomers, oligomers or polymers of the matrix material. The organic solvent can also act as a solvent for such monomers, oligomers or polymers.

The organic solvent can be a polar or non-polar solvent. If it is non-polar and is not miscible with water, it will usually be used with a polar solvent. By such a solvent system, compatibility of the system with the hydrophilic clay layers and the hydrophobic molecules which may be used as a modifier or as the monomer, polymer or oligomer can be achieved.

The organic solvent is preferably of a low boiling point in order that the reactions may be conducted at a low temperature and so that the solvent after performing its function can be easily removed by evaporation.

Preferred organic solvents include, but are not limited to, ketones such as acetone, methyl ethyl ketone, methyl isobutyl ketone and cyclohexanone; alcohols such as methanol, ethanol, propanol, n-butanol, i-butanol, sec-butanol and tert-butanol; glycols such as ethylene glycol, propylene glycol and butylene glycol; esters such as methyl acetate, ethyl acetate, butyl acetate, diethyl oxalate and diethyl malonate; ethers such as diethyl ether, ethylene glycol dimethyl ether, diethylene glycol dimethyl ether and tetrahydrofuran; halogenated hydrocarbons such as dichloromethane, 1,2-dichloroethane, 1,4-dichlorobutane, trichloroethane, chlorobenzene and o-dichlorobenzene; hydrocarbons such as hexane, heptane, octane, benzene, toluene and xylene. Others include N-methyl-2-pyrrolidone, N,N-dimethylacetamide, N,N-dimethylformamide, dimethyl sulfoxide, tetramethylurea, hexamethylphosphoric triamide, and gamma-butyrolactone. These solvents may be used either singly or in any combination thereof. A solvent or a combination therefore with a boiling point below 100° C. is generally preferred for ease of handling and low cost. Preferably, the solvent is acetone.

In the process of the invention, the clay is first mixed with an amount of water sufficient to swell the clay to the desired extent i.e. to achieve substantially complete exfoliation of the clay layers. The actual amount of water required to achieve this will clearly vary depending on the clay type. The weight ratio of clay to water can vary from 1:1 to 1:1000. Preferably, the ratio of clay to water is equal to or greater than 1:10, in one embodiment the ratio of clay to water is equal to or greater than 1:20. For example, the ratio of clay to water may be from 1:10 to 1:200, from 1:10 to 1:500, or from 1:10 to 1:1000. In a further embodiment the ratio of clay to water may be from 1:20 to 1:200, from 1:20 to 1:500, or from 1:20 to 1:1000. In one embodiment, the ratio of clay to water is from about 1:20 to about 1:150.

The ratio of the amount of water to the amount of organic solvent can vary widely as long as the clay remains in a swollen state after the solvent exchange step. The amounts can vary from 1:1 to 1:50.

The clay used in the formation of the nanocomposites is one generally utilized in the prior art. Thus it can be selected from the group consisting of smectite and kaolin clays. Preferably, the clay is a 2:1 layered smectite clay. Smectite clays for use in the current invention can be selected from the group consisting of montmorillonite, hectorite, saponite, sauconite, beidellite, nontronote, and combinations of two or more thereof. More preferably the clay is selected from the group consisting of hectorite, montmorillonite, beidellite, stevensite, and saponite. Typically the clay used in the current invention will have a cation-exchange capacity ranging from about 7 to 300 meg/100 g.

The amount of clay used in the nanocomposites of the current invention will vary depending upon the desired properties in the final nanocomposite and generally range from about 0.01% to 40% by weight based on the total weight of the nanocomposite composition.

The modifier of the current invention can be those referred to in the prior art. The modifiers normally have a function to react with the clay surface and with the matrix material. The clay surfaces are hydrophilic. The matrix material monomers, oligomers or polymer chains can vary from hydrophobic to having some degree of hydrophilicity. The modifier will have both a hydrophilic and a hydrophobic functional group. Hence the modifier can be selected from the group consisting of surfactants, coupling agents, compatibilizers. Suitable modifiers can be selected from alkylammonium salts, organosilanes, alkyl acids (or functional derivatives thereof, such as an acid chloride or anhydride), grafted copolymers and block copolymers. In each case the modifier will be selected so that it has a functional group that can bond to the clay layers and another functional group that can bond to the polymer. It is a feature of the current invention that the modifier can be used in a much lower amount than is proposed in prior art methods. Hence, the amount of modifier can be reduced to an amount within the range of 0.15 to 15 weight percent of clay. In one preferred embodiment, the modifier is a silane coupling comprising a group suitable for reacting with a complimentary functional group on the matrix material. Suitably, the coupling agent is an amino-containing silane. Preferably, the coupling agent is (3-aminopropyl)trimethoxysilane (APTMS available from Sigma-Aldrich).

In one embodiment, the weight ratio of silane coupling agent to pristine clay is from 0.0001:1.0 to 0.5:1.0. Preferably, the weight ratio of silane coupling agent to pristine clay is about 0.1:1.0.

The matrix material will be a polymer (or may comprise monomers or oligomers which can be polymerized) and can be selected from any polymers normally used in a composite in the prior art. Hence polymers chosen from thermosetting polymers, thermoplastic polymers, and combinations thereof can be employed. Epoxy resin is a preferred thermosetting polymer due to its excellent heat resistance, high elastic modulus and good chemical resistance.

The polymers can be incorporated in the process of the invention as a polymerizable monomer and then polymerized. Such polymers include thermosetting polymers such as epoxies, polyester resins and curing rubbers; thermoplastic polymers such as polyolefins which can consist of polyethylenes, polypropylenes, polybutylenes, polymethylpentene, polyisoprenes and copolymers thereof, copolymers of olefins and other monomers such as ethylene-vinyl acetate, ethylene acid copolymers, ethylene-vinyl alcohol, ethylene-ethyl acrylate and ethylene-methyl acrylate, polyacrylates such as polymethyl methylacrylate, polybutyl acrylate, polyethyl methacrylate, polyisobutyl acrylate, poly (2-ethylhexyl acrylate), poly (amino acrylates), poly (hydroxyethyl methacrylate), poly (hydroxypropyl methacrylate), or other polyalkyl acrylates; polyesters such as polyarylates, polybutylene terephthalate and polyethylene terephthalate; polystyrene and copolymers such as ABS, SAN, ASA and styrene-butadiene; engineering resins such as polycarbonate, polyetherimide, polyetheretherketone, polyphenylene sulphide and thermoplastic polyimides; elastomers such as a olefinic TPE's, polyurethane TPE's, and styrenic TPE's; chlorinated polymers such as PVC and polyvinylidene dichloride; silicones such as polydimethyl siloxane, silicone rubber, silicon resin; fluoropolymers and copolymers with other monomers are useful such as polytetrafluoroethylene, fluorinated ethylene-propylene, perfluoroalkoxy resins, polychlorotrifluoroethylene, ethylenechlorofluoroethylene copolymer, polyvinylidene fluoride and polyvinylfluoride. Additional polymers are nitrile resins, polyamides (nylons), polyphenylene ether and polyamideimide copolymers. Also included are the sulfone based resins such as polysulfone, polyethersulfone and polyarylsulfone. Other families of thermoplastic resins useful in this invention are acetals, acrylics and cellulosics. Liquid crystal polymers, a family of polyester copolymers, can also be used. In addition, miscible or immiscible blends and alloys of any of the above resin combinations are useful for this invention.

In one preferred embodiment, the matrix material is an epoxy matrix material. The epoxy matrix material may comprise an epoxy-containing monomer, oligomer, polymer or any combination thereof. Preferably, the epoxy-containing monomer is selected from the group consisting of diglycidyl ether of bisphenol A, diglycidyl ether of bisphenol F and tetraglycidyl-4,4′-diaminodiphenylmethane.

The amount of polymer in the nanocomposite can vary from about 60% up to about 99.9% by weight of the total composition depending on the desired application. The preferred polymer content can be 80% to 99.5%; more preferably 85% to 99.5%.

The nanocomposite produced by intercalation of exfoliated clay into an, for example epoxy matrix material, can be cured using a range of curing agents which are known in the art. For example, the curing agent may be diethyltoluenediamine, 4-[(4-aminophenyl)methyl]aniline, 4,4′-diaminodiphenylsulfone or any combination thereof.

The invention will now be described with reference to the following examples but is not to be construed as limited thereto.

### EXAMPLES

### Example 1

### Prior Art Nanocomposite Formation

2 grams of Cloisite 93A, a commercial organoclay containing 40 wt % of alkylammonium, was mixed with 60.8 g of Dow epoxy resin DER332 by using a homogenizer for 2 hours at a speed of 10000 rpm. The mixture then mixed with 16 g curing agent (ETHACURE 100 LC) by stirring and cured at 100° C. for 2 hours 180° C. for 5 hours. The final product was a plate and was subjected to a number of tests.

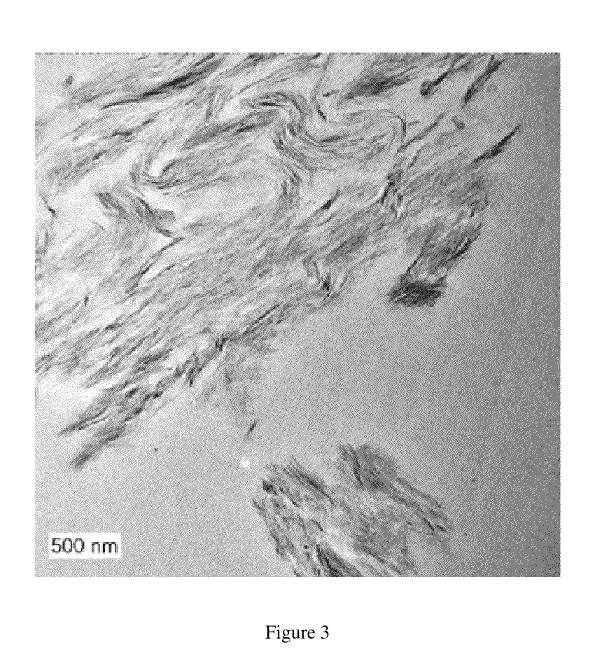

The optical micrograph is shown in FIG. 1. The TEM micrograph is shown in FIG. 3.

### Example 2

### Nanocomposite Formation

2 grams of purified sodium montmorillonite having a cation exchange capacity of 145 meg/100 g, was mixed with 100 ml of water, with stirring for 24 hours at room temperature to form a suspension. The suspension was precipitated in 1000 ml of acetone at room temperature with stirring and washed with acetone at room temperature three times. 3-aminopropyltrimethoxy-silane was added as the coupling agent in an amount of 0.1 g. The mixture was then stirred for 12 hours at room temperature. 60.8 g of Dow epoxy resin DER 332 was mixed thoroughly with the modified clay using a homogenizer for 2 hours at a speed of 10000 rpm. The mixture was dried in a vacuum oven at 50° C. for 48 hours and then mixed with 16 g curing agent (ETHACURE 100 LC, diethyltoluenediamine available from Albemarle) by stirring and cured at 100° C. for 2 hours and 180° C. for 5 hours. The final product was a plate and was subjected to a number of tests.

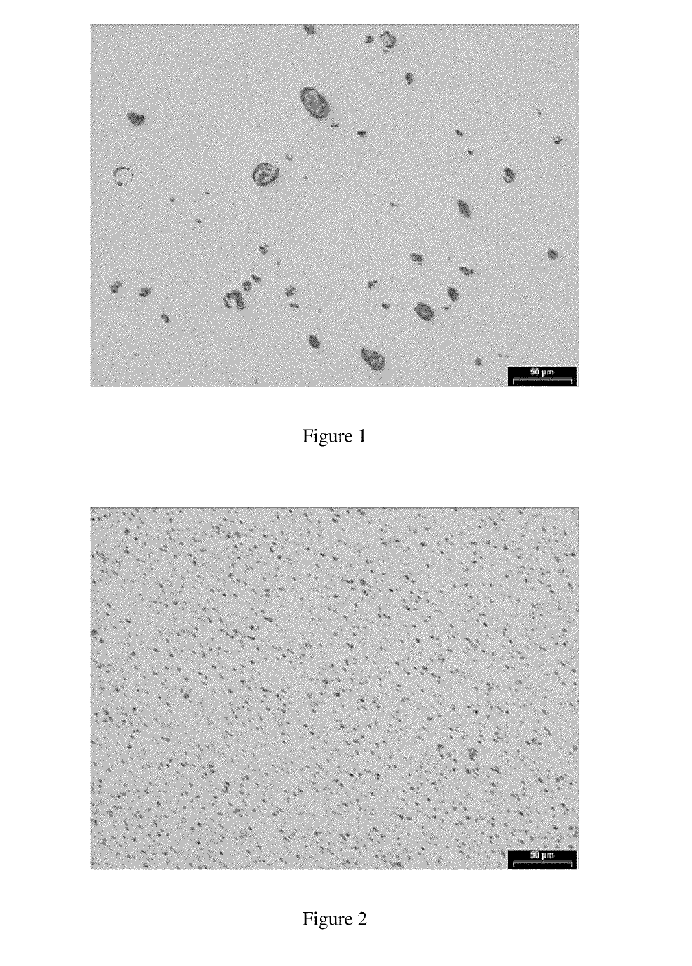

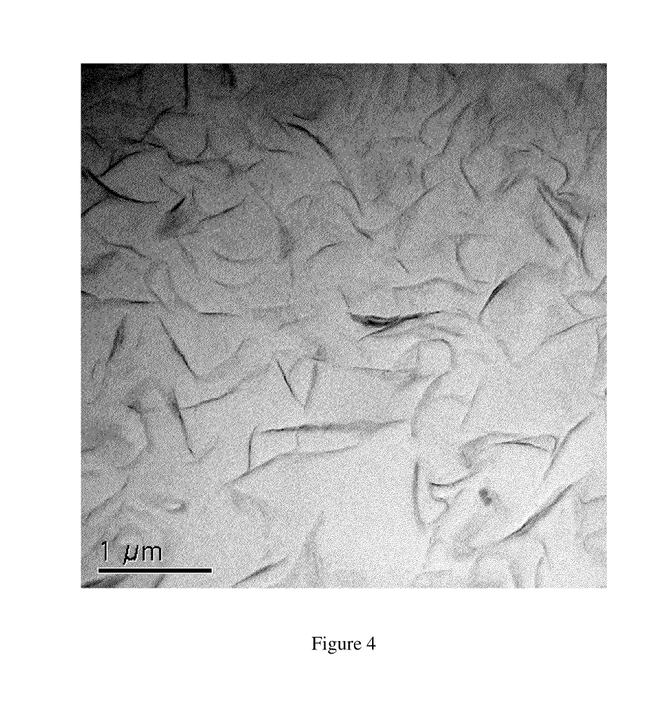

The optical micrograph for this product is shown in FIG. 2 and the TEM micrograph is shown in FIG. 4.

Optical microscope (OM) observations confirmed that the clay particles have uniformly dispersed in the matrix in the nanocomposites prepared using the technique of the present invention. In the epoxy/organoclay nanocomposite prepared using the prior art technique, the aggregate size is 10-20 micron (FIG. 1). In the inventive epoxy/clay nanocomposite, clay particles are uniformly dispersed in the matrix and the size of the aggregates is less than 1 micron (FIG. 2).

The results of a transmission electron microscopic (TEM) study show that the clay is highly exfoliated and the clay layers are uniformly dispersed in the epoxy matrix (FIG. 4), which is significantly superior to that of the samples made with the existing prior art technique (FIG. 3).

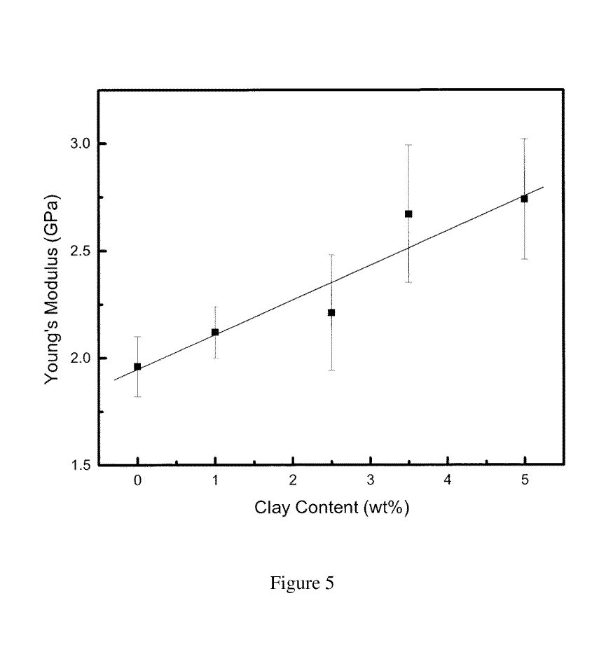

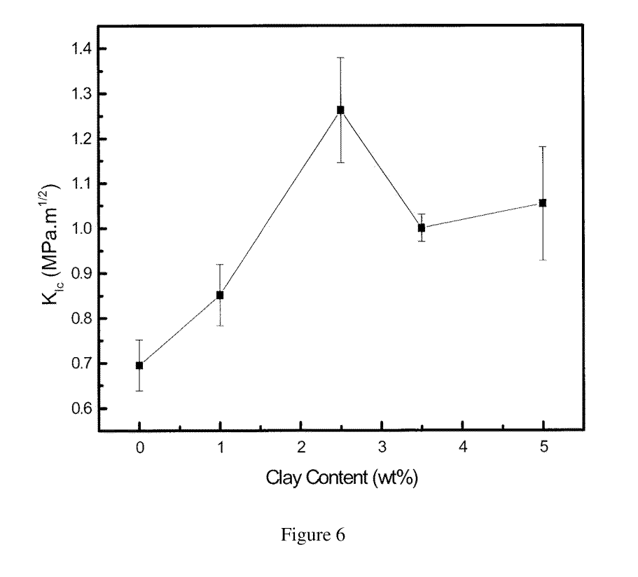

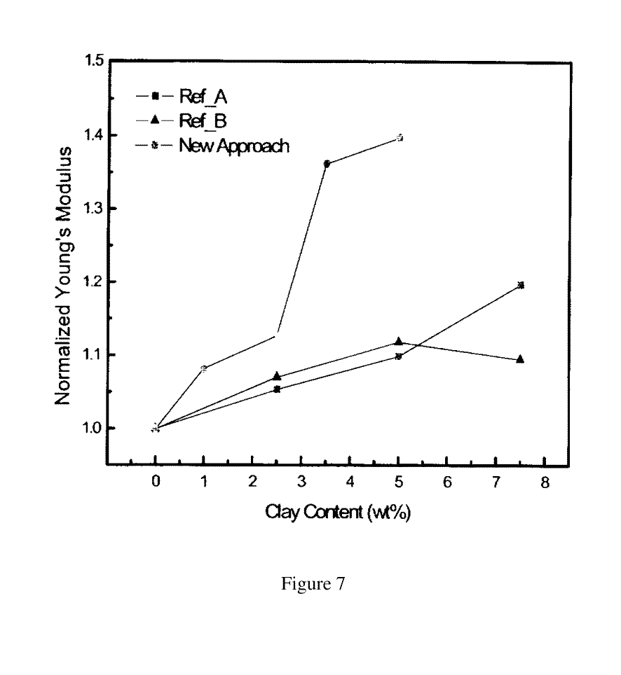

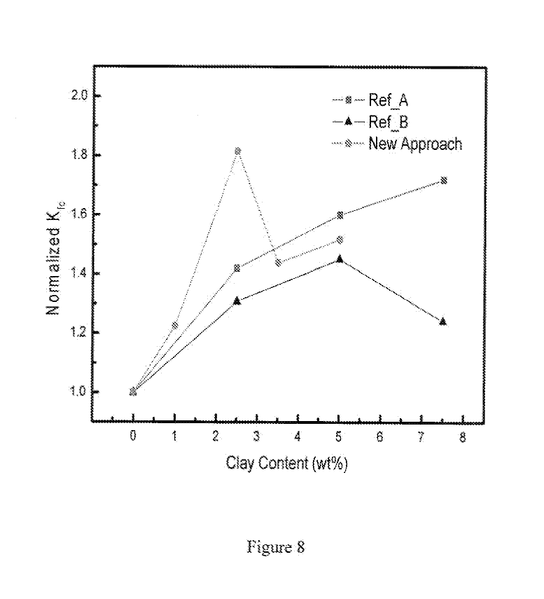

The incorporation of clay into epoxy improves both the Young's modulus (FIG. 5) and fracture toughness (FIG. 6). At a clay load of 2.5 wt %, the fracture toughness shows a maximum value (FIG. 6). Compared with data reported in the literature, the nanocomposites prepared with the process of the invention show better performance in terms of both Young's modulus and fracture toughness. An example is shown in FIGS. 7 and 8, in which the data are normalized and compared. It is obvious that the nanocomposites prepared with the process of the invention show higher Young's modulus regardless of the clay content. The maximum value of fracture toughness is higher than that of the samples prepared using the prior art approach.

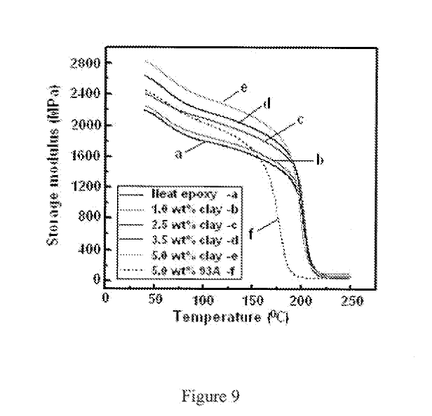

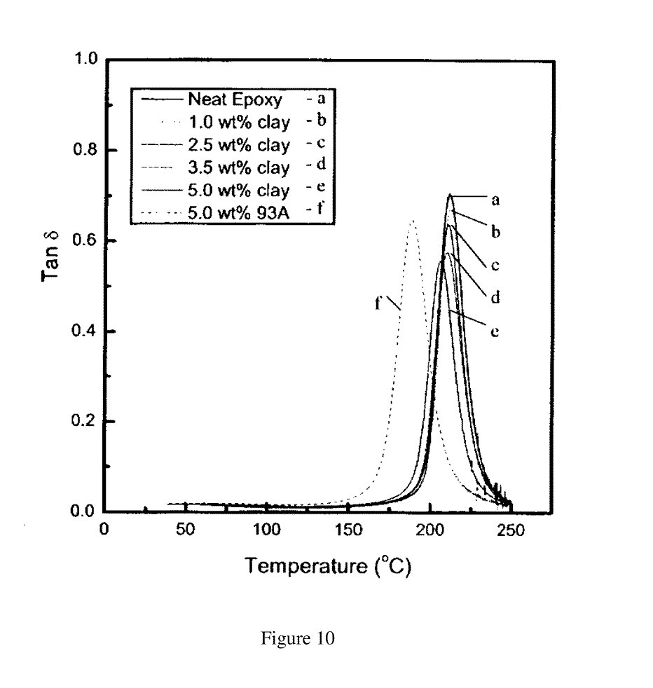

The dynamic mechanical properties of the nanocomposites are shown in FIGS. 9 and 10, together with that of an epoxy/organoclay prior art nanocomposite (epoxy/93A). It can be seen that the storage modulus of the nanocomposites formed using the process of the invention increases with clay load, while the Tg didn't vary to any real extent. For the epoxy/organoclay, however, the storage modulus is lower for the same load, and the Tg has decreased dramatically.

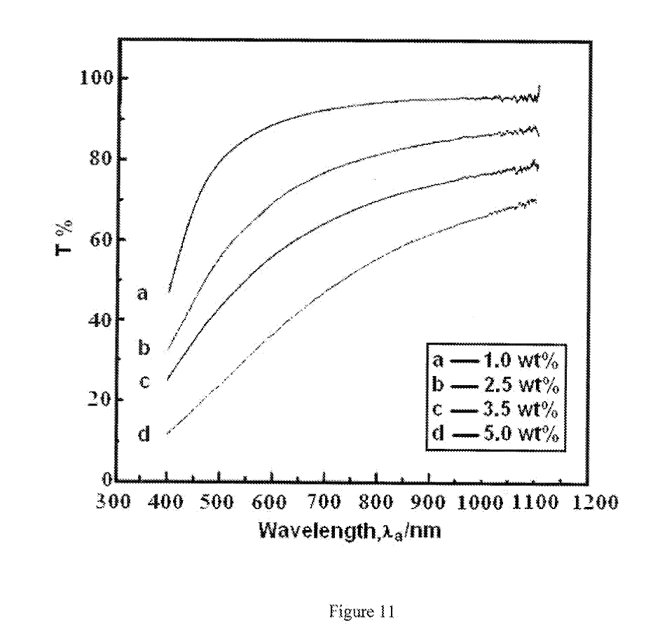

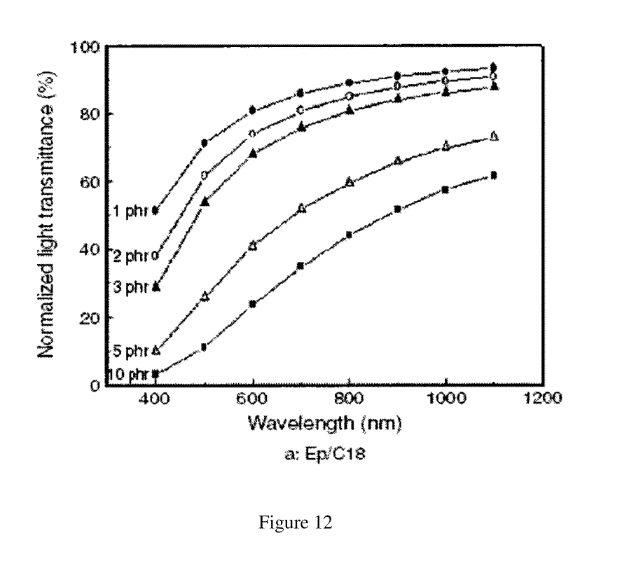

FIGS. 11 and 12 show a comparison of transmittance. Because the clay dispersion and exfoliation have been improved using the process of the invention, the transmittance of the new epoxy/clay nanocomposites (FIG. 11) is better than that of the nanocomposites prepared with the existing prior art approaches (FIG. 12).

### Example 3

### Nanocomposite Formation

2 grams of purified sodium montmorillonite having a cation exchange capacity of 145 meq/100 g was mixed with 100 ml of water with stirring for 24 hours at room temperature to form a suspension. The suspension was precipitated in 1000 ml of acetone at room temperature with stirring and then washed with acetone at room temperature three times. 3-glycidopropyltrimethoxy-silane was added as the coupling agent in an amount of 0.1 g. The mixture was then stirred for 12 hours at room temperature. 50 g of Ciba epoxy resin LY5210 was then thoroughly mixed with the modified clay using a homogenizer for 2 hours at a speed of 10000 rpm. The mixture was dried in a vacuum oven at 50° C. for 48 hours and then mixed with 25 g curing agent (Ciba HY2954) by stirring and cured at 160° C. for 2 hours and 220° C. for 2 hours. The final product was a plate and was subjected to a number of tests.

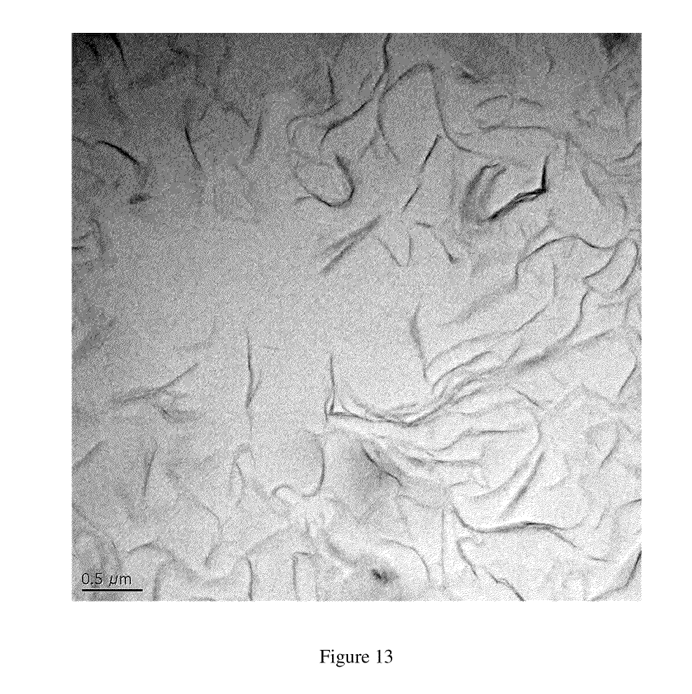

The TEM micrograph shows that the clay is highly exfoliated and the clay layers are uniformly dispersed in the epoxy matrix (FIG. 13), which is significantly superior to that of the sample made using the existing prior art technique (FIG. 3).

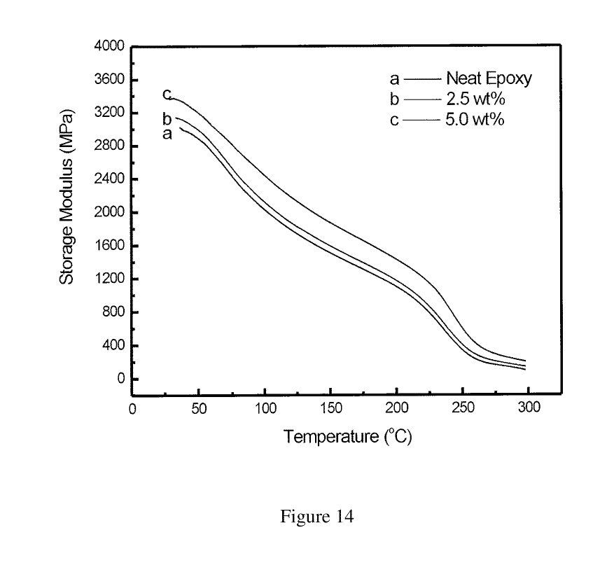

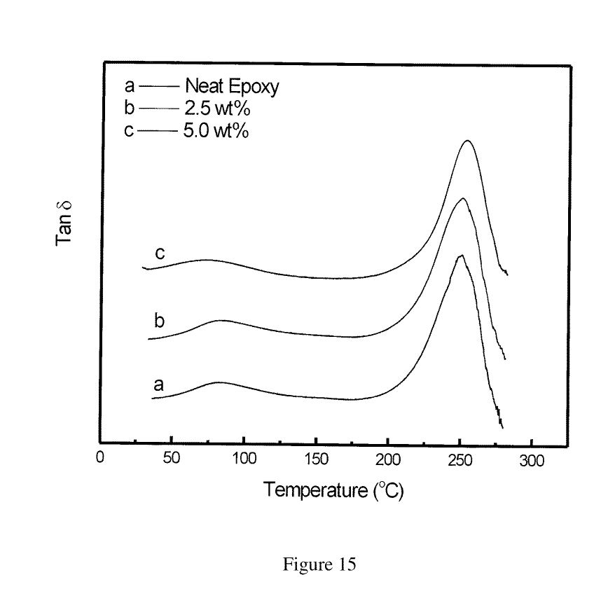

The dynamic mechanical properties of the nanocomposites are shown in FIGS. 14 and 15. It can be seen that both the storage modulus and Tg of the nanocomposites made according to the process of the invention increase with the clay load.

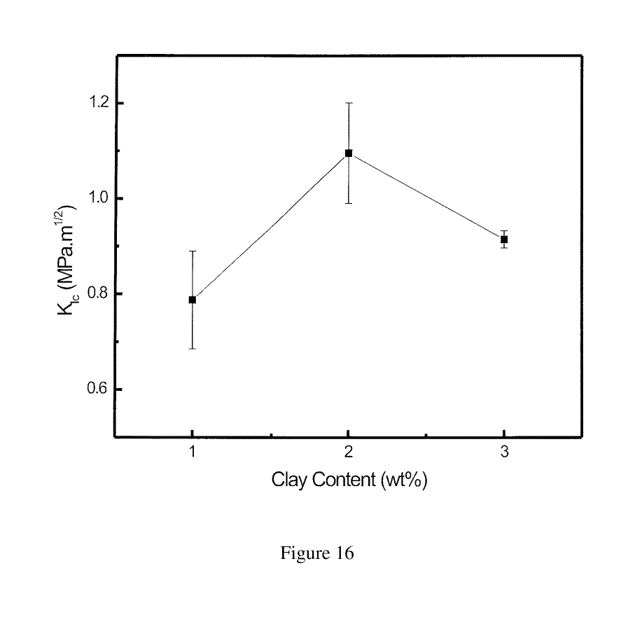

The incorporation of clay into epoxy also improves fracture toughness (FIG. 16). At a clay load of 2.5 wt %, the fracture toughness shows a maximum value.

### Example 4

### Nanocomposite Formation

2 grams of purified sodium montmorillonite having a cation exchange capacity of 145 meq/100 g was mixed with 100 ml of water with stirring for 24 hours at room temperature to form a suspension. The suspension was precipitated in 1000 ml of ethanol at room temperature with stirring and then washed with ethanol at room temperature three times. 3-aminopropyltrimethoxy-silane was added as the coupling agent in an amount of 0.1 g. The mixture was then stirred for 12 hours at room temperature. 60.8 g of Dow epoxy resin DER 332 was then thoroughly mixed with the modified clay using a homogenizer for 2 hours at a speed of 10000 rpm. The mixture was dried in a vacuum oven at 60° C. for 48 hours and then mixed with 16 g curing agent (ETHACURE 100 LC) by stirring and cured at 100° C. for 2 hours and 180° C. for 5 hours. The final product was a plate and was subjected to a number of tests.

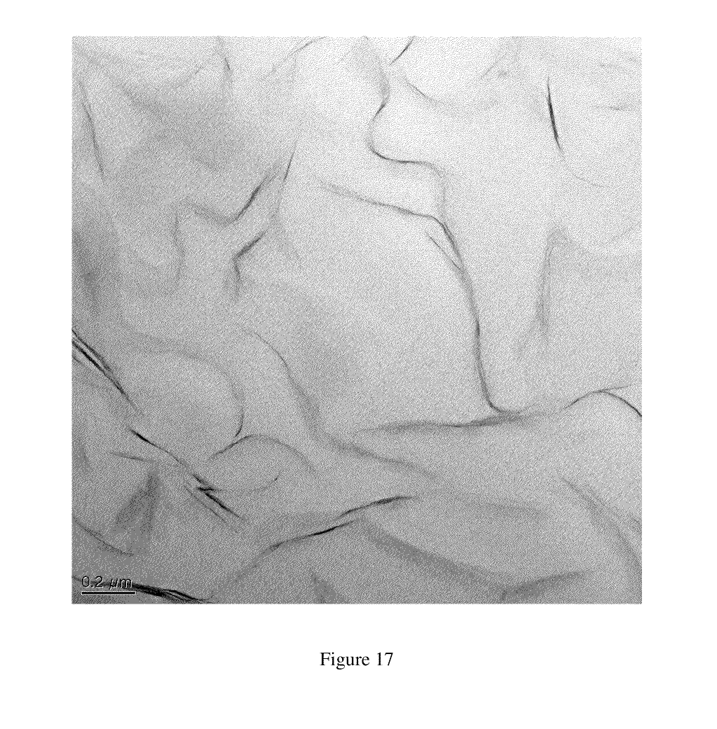

The TEM micrograph show that the clay is highly exfoliated and the clay layers are uniformly dispersed in the epoxy matrix (FIG. 17), which is significantly superior to that of the sample made using the existing prior art technique (FIG. 3).

### Example 5

### Nanocomposite Formation

2 grams of purified sodium montmorillonite having a cation exchange capacity of 145 meq/100 g was mixed with 100 ml of water with stirring for 24 hours at room temperature to form a suspension. The suspension was precipitated in 1000 ml of acetone at room temperature with stirring and then washed with acetone at room temperature three times. 3-glycidopropyltrimethoxy-silane was added as the coupling agent in an amount of 0.1 g. The mixture was then stirred for 12 hours at room temperature. 60.8 g of Dow epoxy resin DER 332 was then thoroughly mixed with the modified clay using a homogenizer for 2 hours at a speed of 10000 rpm. The mixture was dried in a vacuum oven at 50° C. for 48 hours and then mixed with 16 g curing agent (ETHACURE 100 LC) by stirring and cured at 100° C. for 2 hours and 180° C. for 5 hours. The final product was a plate and was subjected to a number of tests.

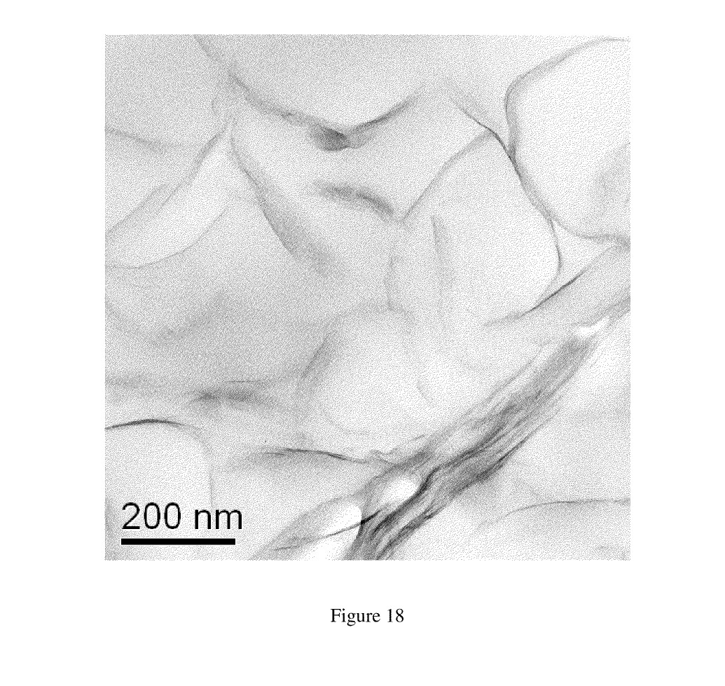

The TEM micrograph shows that the clay is highly exfoliated and the clay layers are uniformly dispersed in the epoxy matrix (FIG. 18), which is significantly superior to that of the sample made using the existing prior art technique (FIG. 3).

### Example 6

### Composite Material Formation

Preparation of a fibre-reinforced 1 wt % silanized clay/epoxy nanocomposite and application to a fibre fabric:

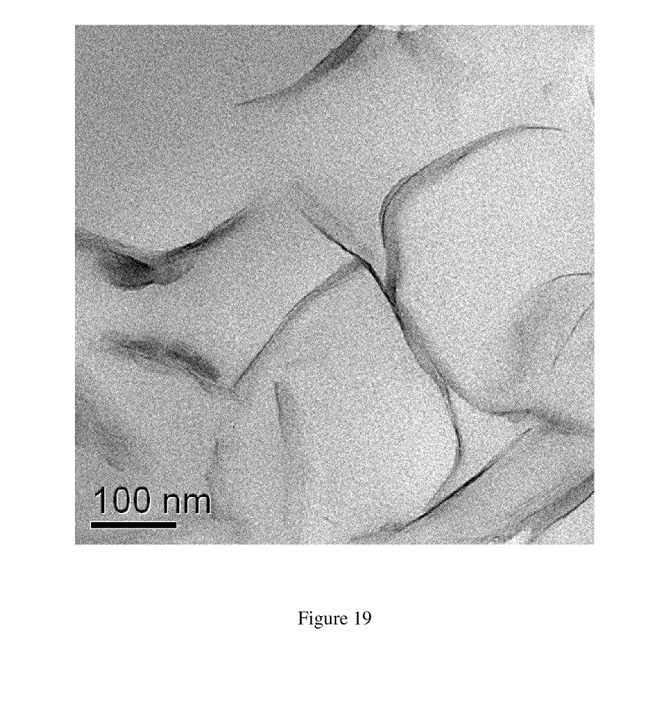

1.54 grams of sodium montmorillonite (Nanocor Inc.) was stirred with 150 ml of water for 24 hours and allowed to settle at room temperature for 2 days. The supernatant was separated from the settled impurities at the bottom of the container and washed with 1000 ml of acetone for three times using a homogenizer. 0.15 ml of (3-aminopropyl)trimethoxysilane (APTMS from Sigma-Aldrich) was injected as the coupling agent into the highly exfoliated clay nanoparticles in acetone. The suspension was stirred at 75° C. for 5 h before being homogenized with 121.6 g of epoxy resin (Diglycidyl ether of bisphenol A, D.E.R.™ 332 Dow) at room temperature for 1 h. After the evaporation of solvent, 32 g of curing agent was added (diethyltoluenediamine, Ethacure 100-LC from Albemarle). The mixture was then degassed at 75° C. to obtain a highly exfoliated clay/epoxy nanocomposite as can clearly be seen in the TEM image shown in FIG. 19.

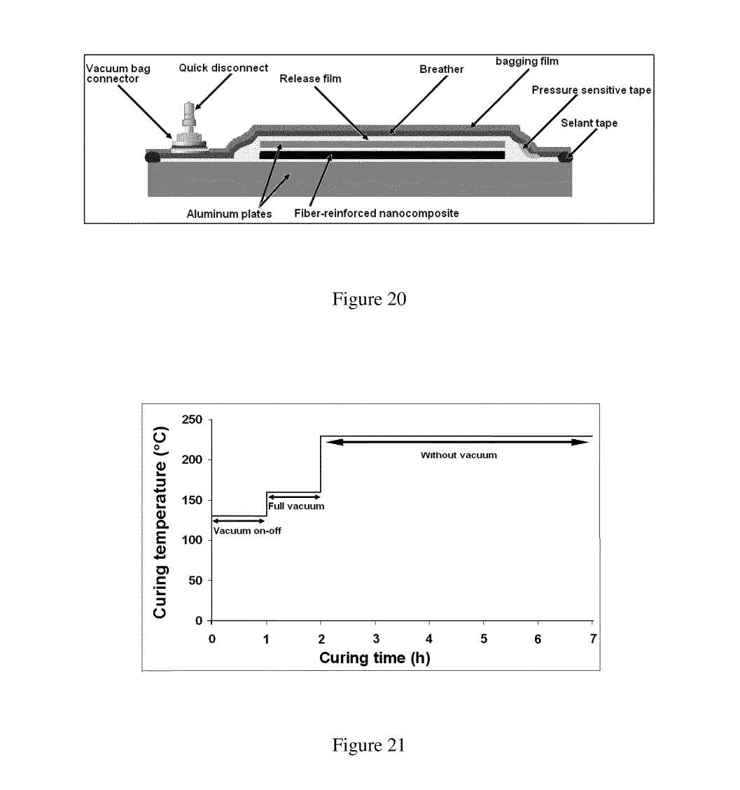

The nanocomposite thus obtained was then applied onto a woven carbon fibre fabric (TORAYCA T300 from TORAY) by a wet lay-up process to obtain a total number of fibre layers of 16 plies. The laminate was then heat cured using a vacuum bagging apparatus as is illustrated in FIG. 20 which involved placing the composite between two plates of a hot press machine in which a quick disconnect was connected to a vacuum pump. The curing process was conducted as shown in FIG. 21 which is a graphical representation of the curing profile.

### Example 7

### Composite Material Formation

Preparation of a fibre-reinforced 2.5 wt % (clay in epoxy resin) silanized clay/epoxy nanocomposite and application to a fibre fabric:

A silanized clay/epoxy nanocomposite was prepared using a similar process as described in Example 6 but with a 0.025:1.0 weight ratio of clay:total nanocomposite composition. The nanocomposite thus formed was laminated onto a woven carbon fibre fabric and the fibre-reinforced composite material formed as for Example 6.

### Example 8

### Composite Material Formation

Preparation of a fibre-reinforced 5 wt % (clay in epoxy resin) silanized clay/epoxy nanocomposite and application to a fibre fabric:

A silanized clay/epoxy nanocomposite was prepared using a similar process as described in Example 6 but with a 0.05:1.0 weight ratio of clay:total nanocomposite composition. The nanocomposite thus formed was laminated onto a woven carbon fibre fabric and the fibre-reinforced composite material formed, as for Example 6.

### Example 9

### Comparative Example without Clay

Preparation of a Fibre-Reinforced Neat Epoxy Composite (No Clay):

121.6 grams of epoxy resin and 32 grams of curing agent were mixed together (3.8:1.0 weight ratio of epoxy:curing agent) exactly as for example 6 but without the addition of any clay. The solution was degassed under vacuum at 75° C. to remove moisture and trace amounts of solvent from the mixture before being applied to a woven carbon fibre fabric and the fibre-reinforced composite material formed, as for Example 6.

### Example 10

### Comparative Example without Coupling Agent

Preparation of a fibre-reinforced 1 wt % (clay in epoxy resin) clay/epoxy nanocomposite (no coupling agent used) and application to a fibre fabric:

The process described in Example 6 was repeated but without the addition of the silane coupling agent during nanocomposite formation.

Although Examples 6-10 have been described using a wet lay-up process but it will be appreciated by the skilled addressee that other moulding techniques such as resin transfer moulding, resin infusion moulding and the like could be equally applicable under the appropriate circumstances. This is particularly so since the incorporation of highly exfoliated clay into the nanocomposite reduces the viscosity of same making it easier to adapt to different moulding techniques.

### Methods

### Thermal Properties

Single-cantilever mode of a dynamic mechanical analyser (DMA Q800, TA Instruments) was used to measure the dynamic modulus and glass transition temperature (T_{g}) of the composite materials of Examples 6-10 at a frequency of 1 Hz, using a heating rate of 3° C./min to 250° C. and an oscillation amplitude of 20 μm.

The average percentages of storage modulus were calculated from the plots of storage modulus versus temperature at 20, 100 and 150° C.

### Mechanical Properties

### Flexural Strength and Modulus:

The flexural strength and flexural modulus were determined by the 3-point bending test according to ASTM Standard D 790-96, with a specimen width of 13 mm, length 55 mm and thickness 2.5 mm. The tests were conducted with a crosshead speed of 1 mm/min, at a span length of 40 mm.

### Tensile Strength and Modulus:

The tensile tests were carried out according to ASTM Standard D 638-03 using an Instron 5569 testing machine at a tensile speed of 1 mm/min.

### Mode I Interlaminar Fracture Toughness (G_{lc}):

The G_{lc} values were calculated using the double cantilever beam (DCB) test according to ASTM Standard D 5528-01. The unidirectional composite materials were cut into 125 mm (length)×25 mm (width)×2.5 mm (thickness) sizes.

### Results and Discussion

The properties of the composite materials obtained in Examples 6-10 are summarised in Table 2.

From the results shown in Table 2 it can be clearly seen that reinforced materials with greatly improved mechanical strength were achieved by the incorporation of clay nanoparticles using the process of the present invention. It can be seen that a 46% increase in storage modulus (compared with the fibre-reinforced neat epoxy material of Example 9) was obtained for the composite material prepared in Example 6 using 1 wt % of silanized clay/epoxy nanocomposite. By comparison a 30% increase in storage modulus (compared with the fibre-reinforced neat epoxy material of Example 9) was obtained for the composite material prepared in Example 10 without the use of a silane coupling agent.

The storage modulus of the composite material was reduced when a higher content of clay nanoparticles was loaded into the epoxy matrix (Examples 7 and 8 at 2.5 and 5 wt %, respectively, compared with Example 6 at 1.0 wt %) while the T_{g} value was more or less constant (around 190° C.). This reduction in storage modulus with increasing clay content may be due to the aggregation of the clay particles at high loading bringing about a decrease in interfacial interactions between the clay and epoxy matrix. In any event the storage modulus of the clay-containing composites was higher at all clay % amounts than the sample prepared using neat epoxy (Example 9).

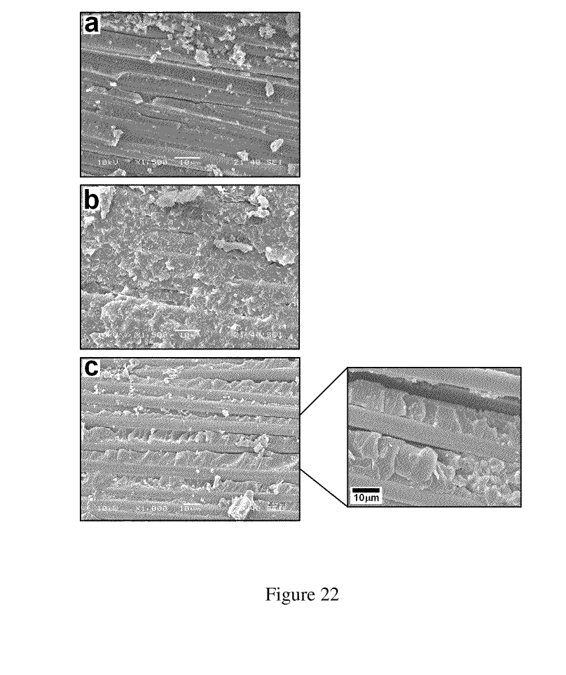

FIG. 22 is a series of scanning electron micrograph (SEM) images showing the fracture surfaces of composite materials made of (a) neat epoxy, no clay (as produced in Example 9); (b) 1 wt % clay in epoxy, no coupling agent (as produced in Example 10); and (c) 1 wt % clay in epoxy with a silane coupling agent (as produced in Example 6). A comparison between the fracture surfaces shows that, in (a) generally smooth and featureless surfaces of laminate layers are found for the neat epoxy sample (Example 9). However, a continuous crack at the interface of carbon fibre and epoxy matrix, representing a brittle failure of the homogeneous epoxy matrix due to low resistance to crack propagation, can also be seen.

FIG. 22(b) shows coverage of woven carbon fibre presented by a rough surface of pristine clay/epoxy nanocomposite (Example 10) and shows the fractures which have occurred inside the nanocomposite structure due to the low interaction between clay nanoparticles and epoxy resin. FIG. 22(c) represents the silanized clay/epoxy mix (Example 6) and shows rougher fracture surfaces than those seen with the neat epoxy. Further, it can be seen that microcracks are torturously propagated around the clay particles forming an extended path producing multi-phase cracks which merge with the main crack, thus, providing for a toughening mechanism and producing the improved results seen in Table 2.

Table 1 below summarises the main components used in Examples 1-5 and the relevant Figures illustrating the properties of the final product.

TABLE 1

| Examples | Polymer Matrix | Clay | Solvent | Modifier | FIGS. |
|---|---|---|---|---|---|
| 1 | DER332 | Organo clay | None | None | 1, 3 |
| 2 | DER332 | Pristine Clay | Acetone | 3-aminopropyltrimethoxy- | 2, 4-12 |
| | | | | silane | |
| 3 | LY5210 | Pristine Clay | Ethanol | 3-glycidopropyltrimethoxy- | 13-16 |
| | | | | silane | |
| 4 | DER332 | Pristine Clay | Ethanol | 3-aminopropyltrimethoxy- | 17 |
| | | | | silane | |
| 5 | DER332 | Pristine Clay | Acetone | 3-glycidopropyltrimethoxy- | 18 |
| | | | | silane | |

Table 2 below summarises the properties of the composite materials obtained in Examples 6-10.

TABLE 2

| | | | | Comparative | |
|---|---|---|---|---|---|
| | Examples | | | examples | |
| | 6 | 7 | 8 | 9 | 10 |
| Clay content (wt %) | 1 | 2.5 | 5 | 0 | 1 |
| Storage modulus | 16,700 | 16,500 | 13,600 | 10,100 | 14,000 |
| (MPa) | | | | | |
| Glass transition | 190 | 190 | 191 | 195 | 186 |
| temperature (° C.) | | | | | |
| Flexural strength | 800 | 442 | 356 | 437 | 445 |
| (MPa) | | | | | |
| Flexural modulus | 59 | 47 | 45 | 45 | 47 |
| (GPa) | | | | | |
| Tensile strength (MPa) | 693 | — | — | 634 | 619 |
| Tensile modulus (GPa) | 94 | — | — | 79 | 77 |
| Average interlaminar | 315 | 177 | 152 | 270 | 230 |
| fracture | | | | | |
| toughness (G_{Ic}, J/m²) | | | | | |

Prior art clay/epoxy composite materials suffer from relatively poor overall mechanical properties which are a result of, firstly, a low degree of exfoliation of clay nanoparticles in the nanocomposite and, secondly, weak interfacial interactions between the clay nanoparticles and the epoxy resin matrix resulting in low interlaminar fracture toughness.

The present invention provides a useful solution to this problem by achieving a high degree of, or even complete, exfoliation of the clay using the process of swelling the clay in water followed by a solvent exchange step with an organic solvent which maintains the clay in a swollen state while providing a more appropriate environment for the intercalation with the epoxy matrix. Further, the use of a silane coupling agent provides for strong covalent bonding between the clay nanoparticles and the epoxy resin which also promotes an increase in the strength of the resulting composite materials.

The silane coupling agent will react with the hydrophilic (typically hydroxyl) groups presented on the clay surface via the hydrolysable silicate groups. This leaves the epoxy reactive group, such as an amine, free to chemically react with the epoxide functionality of the epoxy monomers, oligomers or polymer to strongly bind the two together and provide for improved interlaminar fracture toughness. Due to the high degree of exfoliation of the clay relatively low amounts of the silane coupling agent are required which ensures there is no negative impact from their inclusion or from unreacted material which would be present in only very minor amounts.

The invention therefore provides a nanocomposite in which exfoliated clay particles are uniformly dispersed in a polymer matrix. In one embodiment the present invention relates to a process of forming a nanocomposite comprising treating pristine clay with water in order to swell the clay, intercalating the swollen clay with an organic solvent to form an organic solvent intercalated swollen clay by exchanging the water with the organic solvent while maintaining the swollen clay in a swollen state with the solvent, modifying the organic solvent intercalated swollen clay with a silane coupling agent and mixing the organic solvent intercalated swollen clay so modified with an epoxy matrix material to form a nanocomposite.

Preferably, treating the pristine clay with water results in substantially complete exfoliation of the clay.

If required, the epoxy matrix material may be polymerised after mixing with the organic solvent intercalated swollen clay.

This nanocomposite can then be applied to a reinforcing material to result in a composite material with improved thermal and mechanical properties when compared to those found in the prior art. A number of these layers of nanocomposite coated reinforcing material, for example 2 to 20 layers, preferably 5 to 20 layers, more preferably 16 layers, may be stacked one upon the other to create the final composite material. The number of layers will be chosen depending on the desired thickness and strength required of the composite product.

The nanocomposites of the invention can be used as parts of aircraft, automobile etc. where high modulus and high hardness, high heat distortion temperature and high thermal stability are required; printed circuit boards, electronic packaging, electrical components etc; beverage and food containers, films and coatings etc where high barrier properties and high transparency are required; and tyres, tubes etc. The composite materials of the invention produced by curing of the inventive nanocomposites onto a reinforcing material will have application in similar areas but can be used in situations requiring structural support be provided to bear heavy loads as well.

While this invention has been described with reference to preferred embodiments it is not to be construed as limited thereto. Furthermore where specific materials and steps in the process are referred to and known equivalents exist thereto, such equivalents are incorporated herein as if specifically set forth.

1. A process of forming a composite material comprising:
(a) treating pristine clay with water to form a swollen clay;
(b) intercalating the swollen clay with an organic solvent to form an organic solvent intercalated swollen clay by exchanging the water with the organic solvent while maintaining the swollen clay in a swollen state with the solvent;
(c) modifying the organic solvent intercalated swollen clay with a silane coupling agent;
(d) mixing the organic solvent intercalated swollen clay so modified with an epoxy matrix material to form a nanocomposite; and
(e) applying the nanocomposite to a reinforcing material;
to thereby form a composite material.

2. The process of claim 1 wherein the silane coupling agent has the formula:
(Y—R)ₙSiXₘ
wherein, Y is a functional group which can react with an epoxy group;
R is an alkyl chain; and
X is a hydrolysable group.

3. The process of claim 2 wherein Y is an amine, alcohol or thiol group.

4. The process of claim 3 wherein Y is an amine group.

5. The process of claim 2 wherein R is a two carbon to 8 carbon alkyl chain.

6. The process of claim 5 wherein R is a propyl, butyl or pentyl chain.

7. The process of claim 2 wherein the silane coupling agent is (3-aminopropyl)trimethoxysilane.

8. The process of claim 1 wherein the weight ratio of silane coupling agent to pristine clay is from 0.0001:1.0 to 0.5:1.0.

9. The process of claim 8 wherein the weight ratio of silane coupling agent to pristine clay is about 0.1:1.0.

10. The process of claim 1 wherein the epoxy matrix material comprises an epoxy-containing monomer, oligomer, polymer or any combination thereof.

11. The process of claim 10 further comprising the step of polymerizing the epoxy-containing monomer or oligomer.

12. The process of claim 10 wherein the epoxy-containing monomer is selected from the group consisting of diglycidyl ether of bisphenol A, diglycidyl ether of bisphenol F and tetraglycidyl-4,4′-diaminodiphenylmethane.

13. The process of claim 12 wherein the epoxy-containing monomer is diglycidyl ether of bisphenol A.

14. The process of claim 1 wherein the reinforcing material is selected from the group consisting of carbon fibre, carbon nano fibre, aramid fibre, basalt fibre, glass fibre and Kevlar.

15. The process of claim 14 wherein the reinforcing material is a carbon fibre material.

16. The process of claim 1 wherein the pristine clay is a 2:1 layered smectite clay.

17. The process of claim 16 wherein the pristine clay is a montmorillonite clay.

18. The process of claim 1 wherein the pristine clay is present in an amount of between 0.01 to 40 wt % of the epoxy matrix material.

19. The process of claim 1 wherein the weight ratio of clay to epoxy matrix material is about 0.01:1.0.

20. The process of claim 1 further comprising the step of adding a curing agent to the organic solvent intercalated swollen clay and epoxy matrix material mixture.

21. The process of claim 20 wherein the curing agent is added in a weight ratio of from 3.5:1.0 to 4.0:1.0 of epoxy matrix material to curing agent.

22. The process of claim 21 wherein the curing agent is added in a weight ratio of about 3.8:1.0 of epoxy matrix material to curing agent.

23. The process of claim 20 wherein the curing agent is an aromatic amine or an aliphatic amine.

24. The process of claim 23 wherein the aromatic amine is selected from the group consisting of diethyltoluenediamine, 4-[(4-aminophenyl)methyl]aniline and 4,4′-diaminodiphenylsulfone.

25. The process of claim 1 further comprising the step of removing the organic solvent after forming the nanocomposite.

26. The process of claim 1 wherein the nanocomposite is applied to the reinforcing material using a wet lay-up process.

27. The process of claim 1 further comprising the step of curing the nanocomposite on the reinforcing material.

28. The process of claim 1 wherein the ratio of pristine clay to water is from 1:10 to 1:1000.

29. A composite material made by the process of claim 1.

30. Use of a composite material of claim 29 as a structural component of an article.
